(19) United States
(12) Patent Application Publication
(10) Pub. No.: US 2002/0099941 A1
(43) Pub. Date: Jul. 25, 2002

(54) Email processing method, email processing apparatus and recording medium

(75) Inventor: Yoshifumi Tanimoto, Uji-shi (JP)

Correspondence Address: HOGAN & HARTSON L.L.P., 500 S. GRAND AVENUE, SUITE 1900, LOS ANGELES, CA, 90071-2611, US

(73) Assignee: MURATA KIKAI KABUSHIKI KAISHA

(21) Appl. No.: 10/057,685

(22) Filed: Jan. 23, 2002

(30) Foreign Application Priority Data
Jan. 25, 2001 (JP) 2001-17516

(51) Int. Cl. H04L 9/00

(52) U.S. Cl. 713/168; 380/44

(57) ABSTRACT

When a personal computer receives an email sending instruction from a user and a mailing list is designated as an email destination, the personal computer (PC1) creates a common key from a public key generated based on an email address of the mailing list and a secret key supplied from a center. The personal computer then encrypts email data with the common key, and sends the email including the encrypted data to the mailing list. The email is broadcast to a plurality of recipients registered in the mailing list from a server which handles the mailing list.

### BACKGROUND OF THE INVENTION

1. Field of the Invention

The present invention relates to a method of processing an email when broadcasting the email carrying the same data to a plurality of email addresses of recipients by using, for example, a mailing list and a method of processing an email when receiving the email transmitted via broadcast transmission. The present invention also relates to an apparatus for implementing such methods, and a recording medium for recording a computer program to cause a computer to function as such apparatus.

2. Description of the Related Art

In recent times, various cryptographic techniques are studied to realize safe data communications in connection with a rapid growth of computer network. So far, a common key cryptosystem in which an encryption key is equal to a decryption key, and a public key cryptosystem in which an encryption key is different from a decryption key are widely used. Data Encryption Standards (DES) adopted by National Institute of Standards and Technology of the U.S.A. is a typical example of the common key cryptosystem and Rivest Shamir Adleman (RSA) is a typical example of the public key cryptosystem.

Another cryptosystem is also proposed, which utilizes ID (Identity) information identifying individuals involved in communications such as post office addresses, names and email addresses of the individuals. In this cryptosystem, a common encryption key is generated between a sender and a receiver based on the ID information.

ID-NIKS (ID-based Non-Interactive Key Sharing Scheme) is studied as the cryptosystem which uses the ID information and does not require preliminary communications between a sender and a receiver prior to cryptographic communications. The ID-NIKS cryptosystem does not need to exchange a public key and a secret key between the sender and receiver. In addition, the ID-NIKS cryptosystem does not require a key list and services from a third party. With the ID-NIKS cryptosystem, therefore, safe communications can be ensured between arbitrary users. In particular, this cryptosystem is convenient for users since no preliminary communications are necessary. Accordingly, it is supposed to be a core of the cryptosystem in the future.

FIG. 5 of the accompanying drawings illustrates the principle of the ID-NIKS system. Supposing existence of a reliable center, a shared key generating system is established having the center as its core. In FIG. 5, the ID information of an entity A is designated by “h (IDA)”. “h (•)” represents a hash function. The center calculates a secret key SAi for an arbitrary entity A based on a center public information {PCi}, a center secret information {SCi} and the ID information h(IDA) of the entity A as shown below and distributes the secret key SAi to the entity A.

SAi=Fi ({SCi}, {PCi}, h(IDA))

The entity A produces a common key KAB for encryption and decryption of data to be transmitted between the entity A and an arbitrary entity B as shown below, by utilizing the secret key {SAi} of the entity A itself, the center public information {PCi} and ID information h(IDB) of the entity B:

KAB=f ({SAi}, {PCi}, h(IDB))

In the meantime, the entity B produces another common key KBA to be utilized between the entities A and B. If KAB is always equal to KBA, the common keys KAB and KBA can be utilized as the encryption key and the decryption key between the entities A and B.

Now, transmission and reception of an email utilizing the above described ID-NIKS system will be described. First, the sender and receiver of the email respectively acquire a secret key prepared based on their own email addresses (their own ID information) from a center. The sender then generates a common key based on a public key generated based on the receiver's email address (receiver's ID information) and the acquired secret key, encrypts data with the generated common key, and transmits the encrypted data to the receiver via email. On the other hand, the receiver generates a common key based on a public key generated based on the sender's email address (sender's ID information) and the secret key and decrypts the data in the received email with the common key.

Safe sending and receiving of the email can be easily realized by encrypting and decrypting data in the above described manner. The DES (Data Encryption Standard) can be utilized in the above described ID-NIKS cryptographic communications.

A mailing list is usually used when sending the same email to a plurality of recipients. Specifically, an email server which handles (administers, manages) the mailing list broadcasts the email to a plurality of email addresses registered in the mailing list. A plurality of users can therefore receive the same email.

As described earlier, however, the sender needs to encrypt data utilizing its own secret key and the email address of each recipient in the ID-NIKS system. Thus, the sender has to refer to email addresses of a plurality of recipients when broadcasting the same email to these recipients. Thus, the mailing list cannot be efficiently used in the ID-NIKS system.

### SUMMARY OF THE INVENTION

An object of the present invention is to provide an email processing method that can realize easy transmission and reception of emails including encrypted data to and from a plurality of recipients.

Another object of the present invention is to provide a recording medium that records a computer program for causing a computer to function as an apparatus for implementing such email processing method.

According to a first aspect of the present invention, there is provided a method of sending an email to a mailing list in which at least one recipient is registered, comprising the steps of: creating a common key from a public key generated based on an email address of the mailing list and a secret key generated based on an email address of a sender of the email; and sending an email, which includes data encrypted with the common key, to the email address of the mailing list.

Therefore, it is not necessary to encrypt the email data on the basis of email addresses of recipients respectively when sending the same email to these recipients. It is only needed to encrypt the email data on the basis of the email address of the mailing list and the email address of the sender. The encrypted email is sent to the mailing list and in turn to the recipients. Accordingly, the email including the encrypted data can be transmitted to the recipients in an easy manner.

The secret key may be prepared by a center and supplied via email.

According to a second aspect of the present invention, there is provided an email processing method suited for when receiving an email addressed to a mailing list in which at least one recipient is registered, the email processing method comprising the steps of: creating a common key from a secret key generated based on an email address of the mailing list and a public key generated based on an email address of a sender of the email; and decrypting encrypted data included in the email with the common key.

When the recipients registered in the mailing list receive and decrypt the email addressed to the mailing list, the recipients utilize the common key derived from the email address of the mailing list and the email address of the email sender. Thus, the decryption of the email data can be done easily.

According to a third aspect of the present invention, there is provided a computer-readable recording medium comprising: first program code means for causing a computer to create a common key from a public key generated based on an email address of a mailing list, in which at least one recipient is registered, and a secret key generated based on an email address of a sender of the email; and second program code means for causing the computer to send an email including data encrypted with the common key to the email address of the mailing list.

According to a fourth aspect of the present invention, there is provided a computer-readable recording medium suited for when receiving an email addressed to a mailing list in which at least one recipient is registered, the email including encrypted data, the computer-readable recording medium comprising: first program code means for causing a computer to create a common key from a secret key generated based on an email address of the mailing list and a public key generated based on an email address of a sender of the email; and second program code means for causing the computer to decrypt encrypted data included in the email with the common key.

According to a fifth aspect of the present invention, there is provided an apparatus for sending an email to a mailing list in which at least one recipient is registered, the email including encrypted data, the apparatus comprising: means for creating a common key from a public key generated based on an email address of the mailing list and a secret key generated based on a predetermined email address; and means for sending the email including data encrypted with the common key, to the mailing list.

The apparatus may further include a recording medium for storing the secret key generated based on the predetermined email address.

According to a sixth aspect of the present invention, there is provided an apparatus for receiving an email addressed to a mailing list in which at least one recipient is registered, comprising: means for creating a common key from a public key generated based on an email address of a sender of the email and a secret key generated based on an email address of the mailing list; and means for decrypting encrypted data included in the email by utilizing the common key.

The apparatus may further include a recording medium for storing the secret key generated based on the email address of the mailing list.

### BRIEF DESCRIPTION OF THE DRAWINGS

FIG. 1 is a block diagram showing an example of a mailing service system constituted by a plurality of personal computers (i.e., apparatus for carrying out the email processing method of the present invention) and a computer network connecting these personal computers.

FIG. 2 is a block diagram showing a structure of one of the personal computers illustrated in FIG. 1.

FIG. 3 is a flowchart showing the procedure of the personal computer shown in FIG. 1 when sending an email to a mailing list.

FIG. 4 is a flowchart showing the procedure of other personal computers when receiving the email addressed to the mailing list.

FIG. 5 schematically illustrates the principle of the ID-NIKS system.

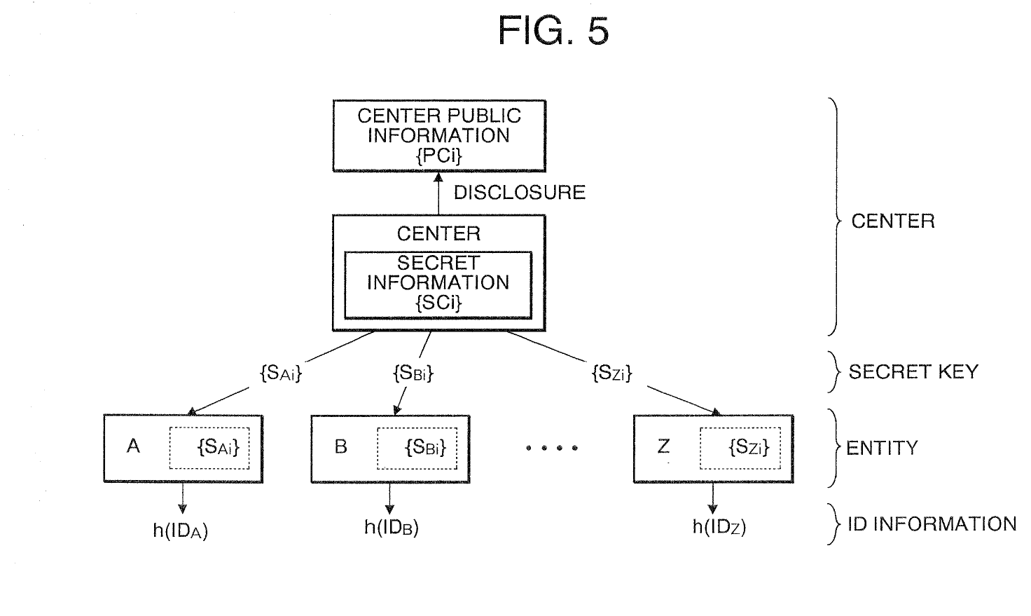

### DETAILED DESCRIPTION OF THE INVENTION

An embodiment of the present invention will be described in detail in reference to the accompanying drawings.

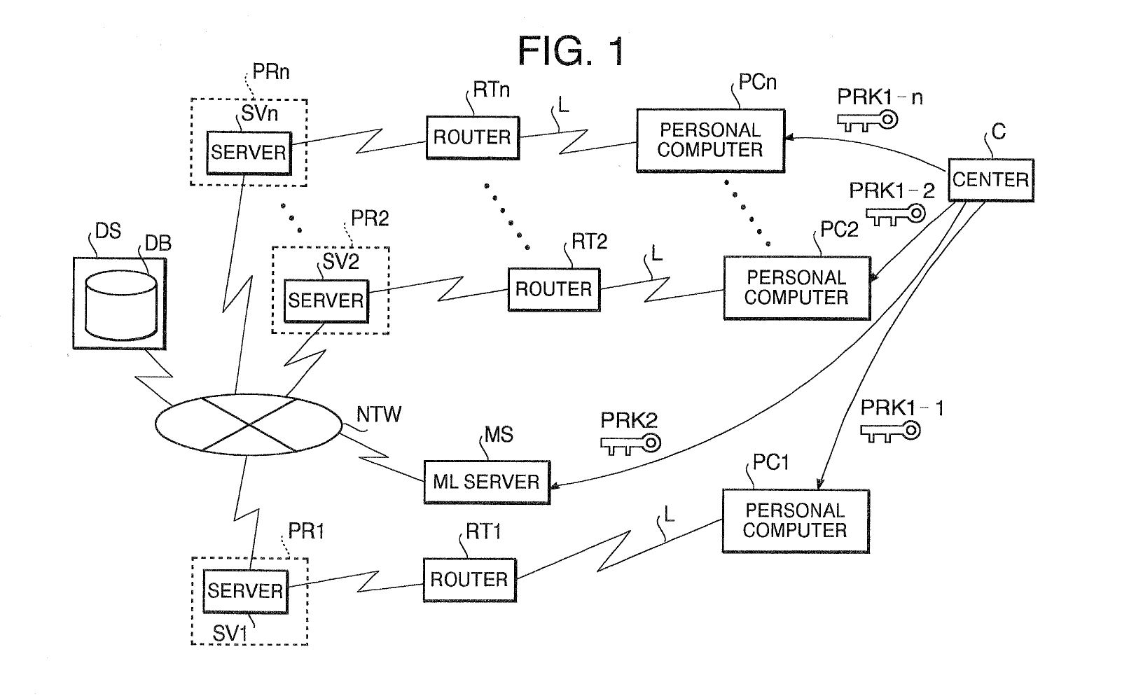

Referring to FIG. 1, illustrated is a block diagram of personal computers PC1, PC2, . . . , PCn (n: natural number) that function as apparatus for implementing an email processing method of the present invention, and a computer network connected to the personal computers PC1, PC2, . . . , PCn.

In FIG. 1, NTW designates the Internet that serves as the computer network. A number of Internet service providers PR1, PR2, . . . , PRn (n: natural number) are connected to the Internet NTW.

The Internet service providers PR1, PR2, . . . , PRn have servers SV1, SV2, . . . , SVn (n: natural number) respectively that function as email servers for sending and receiving emails to and from their clients (i.e., subscribers). SMTP (Simple Mail Transfer Protocol) or POP3 (Post Office Protocol 3) is utilized as an email protocol in this embodiment.

The personal computers PC1, PC2, . . . , PCn (i.e., clients) are connected to the servers SV1, SV2, . . . , SVn of the providers PR1, PR2, . . . , PRn via routers RT1, RT2, . . . , RTn (n: natural number) and analogue lines L.

A center C issues first secret keys PRK1-1, PRK1-2, . . . , PRK1-n to respective users. The first secret keys PRK1-1, PRK1-2, . . . , PRK1-n are prepared on the basis of email addresses of the respective users and sent to the respective personal computers PC1, PC2, . . . , PCn secretly by means of email or the like.

The center C also issues a second secret key PRK2 to a mailing list. The second secret key PRK2 is prepared on the basis of the email address of the mailing list and sent to an email server MS that handles the mailing list by means of email or the like. This email server is referred to as “ML server” hereinafter.

The ML server MS secretly sends an email including the second secret key PRK2 received from the center C to the email addresses registered in the mailing list. Thus, each of the personal computers PC1, PC2, . . . , PCn can receive the second secret key PRK2.

It should be noted that a flexible disk that stores a first secret key PRK1 may be delivered to each personal computer from the center C by post instead of sending the first secret key by email. Likewise, a flexible disk that stores the second secret key PRK2 may be delivered to each personal computer from the ML server MS by post, and a flexible disk that stores the second secret key PRK2 may be delivered to the ML server MS from the center C by post.

A database server DS is connected to the network NTW. The database server DS has a recording medium DB that has recorded a program to operate an email sending apparatus of the present invention. The personal computer PC1 is the email sending apparatus if the personal computer PC1 transmits the email to other personal computers PC2, . . . , PCn.

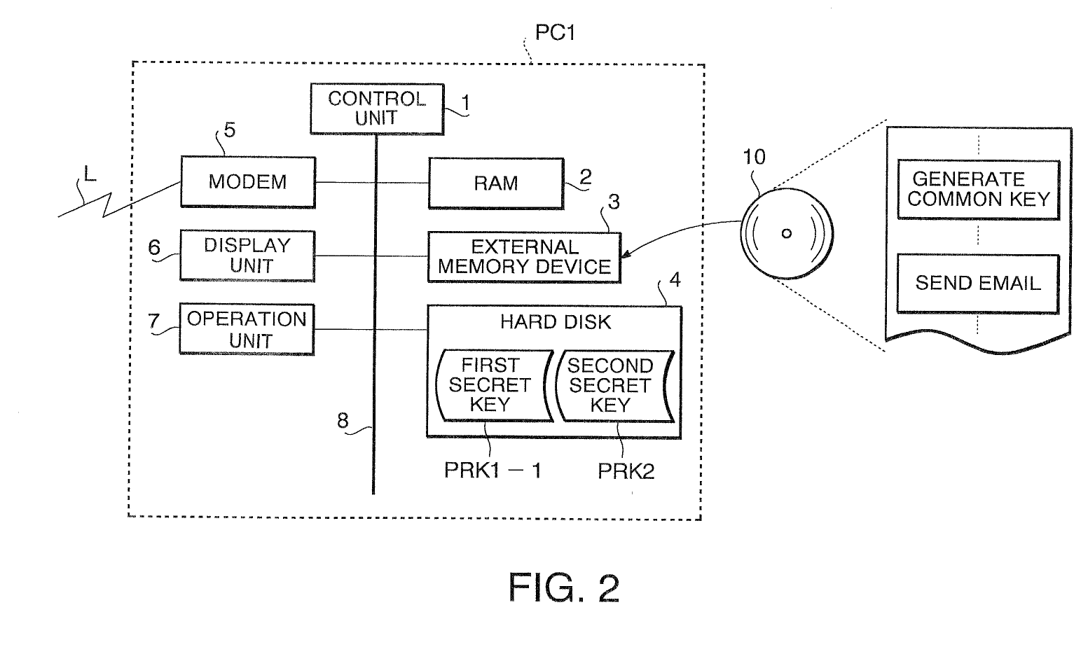

Referring to FIG. 2, illustrated is a block diagram of the personal computer PC1 that functions as an apparatus for implementing the email processing method of the present invention. It should be noted that the structures of the personal computers PC2, PC3, . . . , PCn are the same as that of the personal computer PC1, so that the description of the personal computers PC2, PC3, . . . , PCn will be omitted.

In FIG. 2, the reference numeral 1 designates a control unit that includes a CPU, a cash memory, etc. The control unit 1 controls each hardware element connected thereto via a bus 8. The control unit 1 also executes various computer programs stored on a hard disk 4 (will be described).

A RAM 2 includes an SRAM and/or a DRAM, and stores temporary data generated in the controller 1.

An external memory device 3 includes a CD-ROM drive and/or a flexible disk drive, and reads programs from a portable recording medium 10 such as a CD-ROM and/or a flexible disk. The programs for the email sending method and/or the email processing method of the present invention are recorded on the portable recording medium 10.

A hard disk 4 is a readable and writable magnetic disk, and stores programs for the email apparatus of the present invention, which are read by the external memory device 3, and various computer programs necessary for the operation of the personal computer PC1.

The hard disk 4 also stores the first secret key PRK1-1 and the second secret key PRK2 supplied from the center C.

It should be noted that FIG. 2 shows the structure of the personal computer PC1 so that the hard disk 4 stores the first secret keys PRK1-1. In case of the personal computer PC2, however, the hard disk 4 stores the first secret key PRK1-2, and in case of the personal computer PCn the hard disk 4 stores the first secret key PRK1-n.

The first secret key PRK1-1 is utilized when sending an email, and the second secret key PRK2 is utilized when receiving an email addressed to the mailing list (will be described in detail). Therefore, the second secret key PRK2 is not necessarily stored in the hard disk 4 if the personal computer PC1 only sends an email and does not receive any emails directed to the mailing list (i.e., via the ML server).

A modem 5 is a communication interface for data communications via the Internet NTW, and connects and disconnects the personal computer PC1 to and from the analogue circuit L. It should be noted that the personal computer PC1 can be connected to a digital circuit or network of a baseband transmission system by utilizing a DSU (Digital Service Unit) instead of the modem 5.

A display unit 6 is a CRT display and/or a liquid crystal display (LCD), and displays an operating condition of the personal computer PC1 and various input and output data. An operation unit 7 is a data entry device such as the keyboard necessary for operating the personal computer PC1.

It should be noted that the program for the email processing method of the present invention can be read from other than the portable recording medium 10. For example, by connecting the personal computer PC1 to the database server DS via the Internet NTW, the program can be downloaded from the recording medium DB provided in the database server DS. The downloaded program is then is stored in the hard disk 4. The personal computer PC1 can therefore implement a process (will be described) when the control unit 1 loads the program into RAM 2 from the hard disk 4.

Next, the operation of the personal computers PC1, PC2, . . . , PCn will be described.

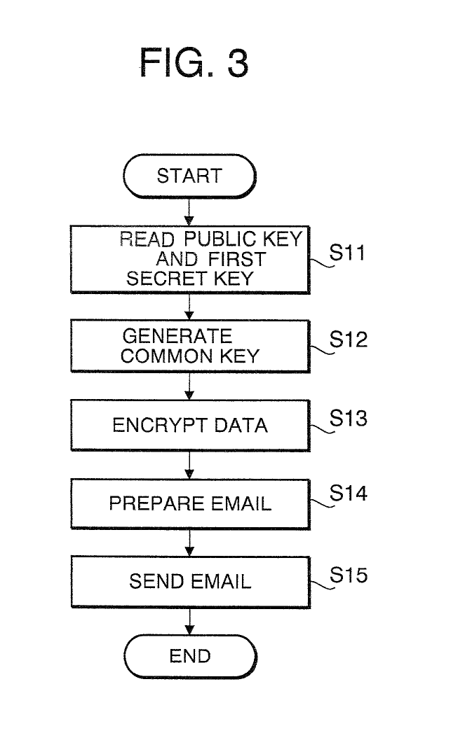

FIG. 3 is a flowchart showing the procedure of the control unit 1 when the personal computer PC1 sends an email to the mailing list. It should be assumed that the personal computer PC1 has finished the logging in operation by sending the user ID, the password, etc. to the provider PR1 which the personal computer PC1 has subscribed for.

A user who subscribes for the mailing list service handled (controlled, managed) by the ML server MS operates the operation unit 7 to input the email address of the mailing list. The mail address of the mailing list is a destination of the email. The user also enters data to be transmitted via email. The user then instructs the personal computer PC1 to send the email.

The control unit 1 provided in the personal computer PC1 reads the public key specified based on the email address of the mailing list and the first secret key PRK1-1 stored in the hard disk 4 when the personal computer PC1 accepts the email transmission instruction from the user (Step S11).

Next, the control unit 1 creates a common key from the public key and the first secret key PRK1-1 that are read in Step S11 (Step S12). The input data is then is encrypted by the DES scheme or the like with the common key (Step S13).

The control unit 1 sets the email address of the mailing list, which is input by the user, to the email destination and prepares the email by utilizing the encrypted data (Step S14). The prepared email is sent to the ML server MS (Step S15).

The email sent from the personal computer PC1 is received by the ML server MS via the server SV1. The ML server MS broadcasts the email received from the personal computer PC1 to the email addresses registered in the mailing list.

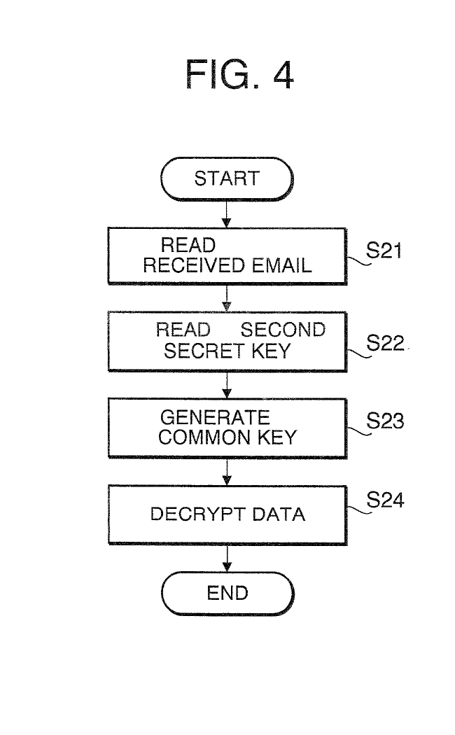

FIG. 4 is a flowchart showing the operation of the control unit 1 of each of the personal computers PC2, . . . , PCn when each of the personal computers PC2, . . . , PCn receives the email, which is addressed to the mailing list It should be assumed that the personal computers PC2, . . . , PCn have already logged in by sending the user IDs, the passwords, etc. to the providers PR2, . . . , PRn which the personal computers PC2, . . . , PCn have subscribed for respectively.

Each of users of the personal computers PC2, . . . , PCn who subscribes for the mailing list service handled by the ML server MS instructs his or her own personal computer PC2, . . . , PCn to receive the email. The control unit 1 of each personal computer PC2, . . . , PCn receives and reads the email addressed to the mailing list, which is sent from the ML server MS, from the associated server SV2, . . . , SVn when the control unit 1 accepts the email reception instruction from the user (Step S21).

Next, the control unit 1 reads the second secret key PRK2 from the hard disk 4 (Step S22). The control unit 1 creates a common key from the second secret key PRK2 and a public key generated based on the email address of the sender of the email that is read in Step S21 (Step S23). The control unit 1 then decrypts the data of the received email with the common key (Step S24).

Therefore, each of the users of the personal computers PC2, . . . , PCn can see and read the content of the encrypted email addressed to the mailing list.

The sending and receiving of the email is implemented by using the mailing list in the illustrated embodiment, but the present invention can be applied to a system which does not rely upon the mailing list, as long as the same email can be broadcasted to a plurality of recipients when a single email address is designated as the email destination.

This application claims priority of Japanese Patent Application No. 2001-17516 filed on Jan. 25, 2001, and the entire disclosure thereof is incorporated herein by reference.

What is claimed is:

1. A method of sending an email to a mailing list in which at least one recipient is registered, comprising the steps of:
creating a common key from a public key generated based on an email address of the mailing list and a secret key generated based on an email address of a sender of the email; and
sending an email, which includes data encrypted with the common key, to the email address of the mailing list.

2. The method according to claim 1, wherein the email is broadcast to the at least one recipient registered in the mailing list from a machine which handles the mailing list.

3. The method according to claim 1, the secret key is generated by a center and supplied via email.

4. An email processing method suited for when receiving an email addressed to a mailing list in which at least one recipient is registered, the email processing method comprising the steps of:
creating a common key from a secret key generated based on an email address of the mailing list and a public key generated based on an email address of a sender of the email; and
decrypting encrypted data included in the email with the common key.

5. The email processing method according to claim 4, wherein the email is broadcast from a remote machine which handles the mailing list.

6. The email processing method according to claim 4, the secret key is prepared by a center and supplied via email.

7. A computer-readable recording medium comprising:
first program code means for causing a computer to create a common key from a public key generated based on an email address of a mailing list, in which at least one recipient is registered, and a secret key generated based on an email address of a sender of the email; and
second program code means for causing the computer to send an email including data encrypted with the common key to the email address of the mailing list.

8. A computer-readable recording medium suited for when receiving an email addressed to a mailing list in which at least one recipient is registered, the email including encrypted data, the computer-readable recording medium comprising:
first program code means for causing a computer to create a common key from a secret key generated based on an email address of the mailing list and a public key generated based on an email address of a sender of the email; and
second program code means for causing the computer to decrypt encrypted data included in the email with the common key.

9. An apparatus for sending an email to a mailing list in which at least one recipient is registered, the email including encrypted data, the apparatus comprising:
means for creating a common key from a public key generated based on an email address of the mailing list and a secret key generated based on a predetermined email address; and
means for sending the email including data encrypted with the common key, to the mailing list.

10. The apparatus according to claim 9 further including a recording medium for storing the secret key generated based on the predetermined email address.

11. The apparatus according to claim 9, wherein the email is broadcast to the at least one recipient from a machine which handles the mailing list.

12. The apparatus according to claim 9, wherein the predetermined email address is an email address of the apparatus.

13. An apparatus for receiving an email addressed to a mailing list in which at least one recipient is registered, comprising:
means for creating a common key from a public key generated based on an email address of a sender of the email and a secret key generated based on an email address of the mailing list; and
means for decrypting encrypted data included in the email by utilizing the common key.

14. The apparatus according to claim 13 further including a recording medium for storing the secret key generated based on the email address of the mailing list.

15. The apparatus according to claim 13, wherein the email is broadcast from a remote machine which handles the mailing list.

16. An apparatus for sending an email including encrypted data to a mailing list in which at least one recipient is registered and for receiving an email addressed to the mailing list, the apparatus comprising:
means for creating a first common key from a public key generated based on an email address of the mailing list and a first secret key generated based on a predetermined email address;
means for sending an email including data encrypted with the first common key, to the mailing list; and
means for creating a second common key from a public key generated based on an email address of a sender of a received email and a second secret key generated based on the email address of the mailing list; and
means for decrypting encrypted data included in a received email by utilizing the second common key.

17. The apparatus according to claim 16 further including a recording medium for storing the first secret key and the second secret key.

18. The apparatus according to claim 16, wherein the email the apparatus sends is broadcast to the at least one recipient from a machine which handles the mailing list.

19. The apparatus according to claim 16, wherein the predetermined email address is an email address of the apparatus.
